(19) United States
(12) Patent Application Publication
(10) Pub. No.: US 2007/0002514 A1
(43) Pub. Date: Jan. 4, 2007

(54) Liquid crystal display capable of producing negative ions

(75) Inventors: Kun-Huang Hsu, Shulin City (TW); Kuo-Yang Cheng, Taipei City (TW); Ling-Ling Cheng, Taipei City (TW); Ho-Ching Huang, Kaohsiung City (TW)

Correspondence Address: REED SMITH LLP, Suite 1400, 3110 Fairview Park Drive, Falls Church, VA, 22042, US

(73) Assignee: Inventec Corporation

(21) Appl. No.: 11/169,798

(22) Filed: Jun. 30, 2005

(51) Int. Cl. H02H 1/00

(52) U.S. Cl. 361/229

(57) ABSTRACT

A liquid crystal display (LCD) capable of negative ion generation is disclosed. The LCD utilizes existing power inverter to generate negative ions by means of corona discharge or silent discharge, which offers an extra function without altering the structural design of existing power inverter while saving the space required for generation of negative ions. In addition, the LCD excites negative ions with little power without affecting its normal operation. Using the LCD disclosed in this invention not only neutralizes the adverse effect of positive ions on human body, the negative ions produced by the display can help purify blood, activate cells, boost immunity, regulate autonomous nerves and remove harmful substances, suspended particles, and odors in air, and kill germs. It benefits the health of people who use computer constantly.

### BACKGROUND OF THE INVENTION

1. Field of the Invention

The present invention relates to a liquid crystal display (LCD) capable of producing negative ions, more particularly a kind of LCD that utilizes existing power inverter to produce negative ions.

2. Description of the Prior Art

Modern gadgets and devices people use in daily life, including television, computer, microwave and electronic products emit electromagnetic waves and produce large amount of positive ions. While we are constantly exposed to such environment, positive ions enter our body continuously. Positive ions are frequently referred to as “fatigue ions.” People exposed to large amount of positive ions tend to feel tired both physically and mentally. Research demonstrates that positive ions lowers body immunity, affects blood circulation, accelerates the process of aging, and adversely affects our health in the long run. Negative ions on the other hand can help the body fight the adverse effect of positive ions and are commonly referred to as “vitamins of the air” that help improve the health of mind and body. Studies show that people tend to be more relaxed in an environment filled with negative ions.

From the perspective of health, negative ions produce four benefits—cleansing blood, activating cells, boosting immunity, and regulating autonomous nerves.

The blood of healthy people is weakly alkaline. Nutrients needed by cells and waste excreted by cells normally pass through cell membrane to enter or exit cells as cells metabolize. For people who have too much meat and seafood in their diet, their blood turns from weakly alkaline to weakly acidic, causing the rapid increase of reactive oxygen (i.e. free radicals) in body, which accelerates the oxidation and ageing of cells. As a result, body immunity weakens and the protective action of cell membrane also declines, making the body susceptible to the invasion of germs. If proper amount of negative ions enter the body at this time, it can reduce the amount of reactive oxygen, slow down cell oxidation, and purify blood.

Pores on cell membrane absorb nutrients into the cell and excrete waste products generated from cell metabolism out of the cell. If the blood becomes weakly acidic which leads to increase in reactive oxygen, accelerates the oxidation of cells and increases the thickness of cell membrane, the pores on cell membrane will function poorly, hence affecting nutrient absorption and waste excretion. If the weak potential carried by negative ions enters the cell at this time, cellular tissue would automatically balance the ion level inside and outside the cell membrane based on the sodium-potassium (Na—K) pump principle to free up the channel of nutrient absorption and waste excretion and activate cells.

The immune system of human body consists of lymphocytes secreted by lymphatic glands, lymph, and white blood cells responsible for engorging bacteria and viruses attacking the body. After the T-lymphocyte identifies invaded cells (e.g. bacteria and viruses) in the body, it would relay the message to B-lymphocyte to produce antibody and memory such information. When the same bacteria or virus invades the body again next time, B-lymphocyte would produce the same antibody to fight against it. This is how vaccination works. Negative ions can activate the functions of immune cells, thereby boosting body immunity.

The transmission of automatic nervous system that controls respiration, circulation, gastrointestinal peristalsis, and metabolism depends on calcium ions. More negative ions in the body increase the level of calcium ions, which enhances nerve transmission and increases enzyme secretion, thereby boosting body immunity.

Negative ions can adhere to airborne dust particles to turn them into a gigantic molecule. Indoor harmful substances (formaldehyde), volatile chemicals, cigarette smokes are predominantly positively charged. Negative ions can adhere to those substances to neutralize their charge and increase their mass by giantization, causing them to drop to the ground, that is, removing them from the air. Negative ions also remove odor by changing the charges carried by odorous substances.

Negative ions kill bacteria by causing the structural change or energy transfer in bacteria after combining with them. The dead bacteria would fall to the ground. This is the major reason why bacteria in natural air decrease by 22% every minute.

Electrical discharge, including corona discharge and silent discharge (also referred to as dielectric barrier discharge), is the most commonly employed method in negative ion generating devices.

In corona discharge, there is usually a high-curvature electrode, such as the tip of a needle or a very thin wire, which ensures high potential gradient around the electrode to facilitate discharge. Depending on the polarity of high-curvature electrode, the corona can be positively or negatively charged. When the electrode has a positive charge, a positive corona is produced; when the electrode has a negative charge, a negative corona is produced. The physical phenomena of positive and negative corona are rather different. Only electrons undergo significant ionized, non-elastic collision under normal atmospheric temperature and pressure due to the huge difference between the mass of electron and positive ion. When air passes through a negative electrode where negative corona is produced, the air is attached by an electron to become negative ion.

### SUMMARY OF THE INVENTION

In light that electronic products send out electromagnetic waves and produce large amount of positive ions which have adverse effect on the body, while negative ions can help fight the adverse effect of positive ions to improve health, remove harmful substances, suspended particles, odors in air, and kill germs, and in light of the fact that liquid crystal display is an electronic product commonly used by people at close distance, the present invention provides a liquid crystal display capable of producing negative ions.

The object of the present invention is to provide an LCD capable of producing negative ions to promote the health of LCD users.

Another object of the present invention is to provide an LCD capable of producing negative ions, characterized in which the existing power inverter is utilized to produce negative ions, hence adding an extra function to the device without altering the structural design of power inverter while saving the space required for generating negative ions.

To achieve the aforesaid objects, the liquid crystal display capable of producing negative ions according to the present invention comprises: an LCD, which includes a power inverter. The power inverter has an output cathode; a metal needle with a tip connected to the output cathode and generating discharge; an insulated sleeve encircling the exposed area of the metal needle and having an air inlet and an air outlet; a separate metal mesh disposed at the air outlet to trap static electricity and prevent the risk of electric shock; wherein air that enters the insulated sleeve through air inlet is attached by the electron discharged from the tip to become negative ion and exit from the air outlet as negatively ionized air.

The design principle, embodiment and functions of the present invention are described in detail with accompanying drawings.

### BRIEF DESCRIPTION OF THE DRAWINGS

FIG. 1A is a schematic view of the elements of an LCD capable of producing negative ions according to the present invention that produce negative ions by corona discharge;

FIG. 1B is a sectional view of an example of negative ion generation by corona discharge according to the invention; and

FIG. 1C is a three-dimensional view of an example of negative ion generation by corona discharge according to the invention.

### DETAILED DESCRIPTION OF THE PREFERRED EMBODIMENT

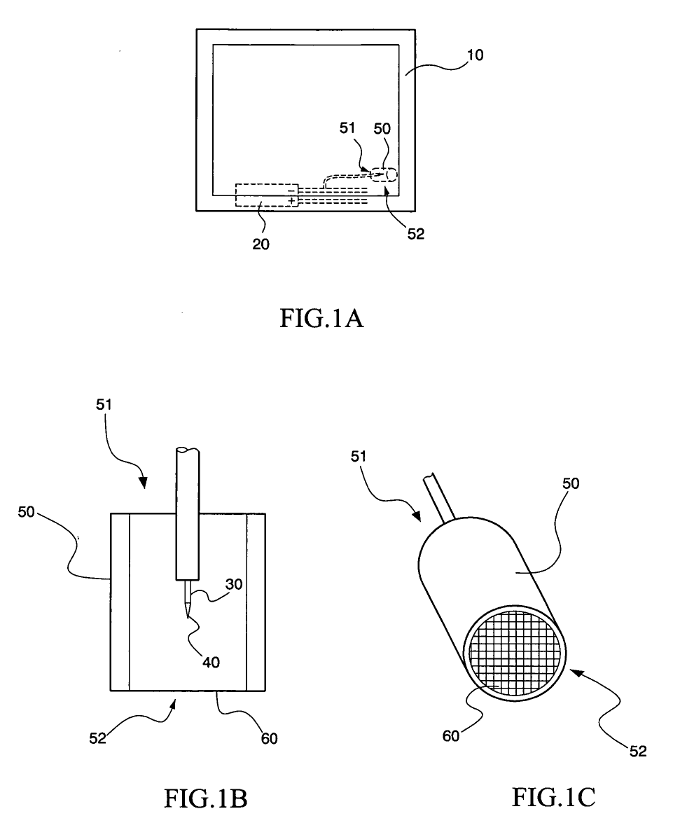

FIG. 1A is a schematic view of the elements of an LCD capable of producing negative ions according to the present invention that produce negative ions by corona discharge. FIG. 1B is a sectional view and FIG. 1C is a three-dimensional view. As shown in FIG. 1A, in an example of negative ion production by corona discharge, the LCD 10 of a desktop or laptop computer or an LCD TV has a power inverter 20 with an output cathode lead; as shown in FIG. 1B, the other end of output cathode is connected to a metal needle 30 made of copper, stainless steel, tungsten or metal alloy and having a tip 40 with extremely small radius of curvature that forms very high potential gradient around it and is ready to discharge; an insulated sleeve 50 encircling the exposed area of the metal needle 30 and having an air inlet 51 and an air outlet 52; the insulated sleeve 50 may be made of plastic material and its cross section is not limited to circular shape; when air enters the insulated sleeve 50 through air inlet 51, it is attached by electron as it passes through the discharge from tip 40 to form negative ion and exits from air outlet 52 as negatively ionized air; by increasing the voltage metal needle 30 is connected to, the amount of negative ions produced also increases which makes the flow of negatively ionized air more obvious; as shown in FIG. 1C, a separate metal mesh 60 is disposed at air outlet 52 to trap static electricity and prevent the risk of electric shock; the separate metal mesh 60 is made of copper, iron, stainless steel, aluminum or alloy.

The example cited above means to illustrate the technical ideas and features of the present invention for people familiar with the skill to understand the invention and implement it and should not be construed as a limitation on the actual application of the invention. All modifications and alterations without departing from the spirits of the invention shall remain within the protected scope and claims of the invention.

What is claimed is:

1. A liquid crystal display (LCD) capable of producing negative ions with existing power inverter, comprising:
An LCD which includes a power inverter, wherein said power inverter having an output cathode;
a metal needle having a tip connected to said output cathode and producing tip discharge; and
an insulated sleeve encircling the exposed area of said metal needle and having an air inlet and an air outlet; wherein air entering said insulated sleeve via said air inlet is attached by electron as it passes through the discharge from the tip of said metal needle to form negative ion and exits from said air outlet as negatively ionized air.

2. The LCD capable of producing negative ions according to claim 1, wherein said metal needle is made of cooper, stainless steel, tungsten or alloy.

3. The LCD capable of producing negative ions according to claim 1, wherein said insulated sleeve is made of plastic material.

4. The LCD capable of producing negative ions according to claim 1, wherein the cross section of said insulated sleeve is circular, square or polygonal in shape.

5. The LCD capable of producing negative ions according to claim 1, wherein increasing the voltage said metal needle is connected to can increase the amount of negative ions produced, rendering the flow of negatively ionized air more apparent.

6. The LCD capable of producing negative ions according to claim 1, wherein said LCD further contains a metal mesh disposed at said air outlet to trap static electricity and prevent the risk of electric shock.

7. The LCD capable of producing negative ions according to claim 6, wherein said metal mesh is made of copper, iron, stainless steel, aluminum or alloy.
